(19) United States
(12) Patent Application Publication
(10) Pub. No.: US 2003/0123516 A1
(43) Pub. Date: Jul. 3, 2003

(54) Quantum-interferometrically enhanced optical nonlinearities for photon switches and logic gates

(76) Inventors: Aephraim M. Steinberg, Toronto (CA); Jeffrey S. Lundeen, Toronto (CA); Kevin J. Resch, Toronto (CA)

Correspondence Address: Ralph A. Dowell, Dowell & Dowell, P.C., Suite 309, 1215 Jefferson Davis Hwy., Arlington, VA, 22202, US

(21) Appl. No.: 10/270,183

(22) Filed: Oct. 15, 2002

Related U.S. Application Data
(60) Provisional application No. 60/328,787, filed on Oct. 15, 2001.

(51) Int. Cl. H01S 3/08

(52) U.S. Cl. 372/102

(57) ABSTRACT

The present invention shows that all-optical switching (nonlinearity) may be enhanced by huge factors (e.g., ten orders of magnitude), making it possible for beams of light to control one another even In the extreme low-light-level regime (down to mean photon numbers smaller than 1). Such photon switches constitute novel quantum optical logic gates which may enable new technologies in quantum information processing as well as other low-light-level optical devices. The present invention also provides a device which greatly enhances nonlinear optical effects between photon pairs in input laser beams via quantum interference. The device is capable of removing all (or nearly all) photon pairs from the input beams, efficiently converting them to their sum frequency.

### CROSS REFERENCE TO RELATED U.S. PATENT APPLICATION

This patent application relates to U.S. provisional patent application Serial No. 60/328,787 filed on Oct. 15, 2001, entitled OPTICAL SWITCH.

### FIELD OF THE INVENTION

This invention relates generally to optical switches based on quantum interference, and more particularly the present invention relates to great enhancements of optical nonlinearities via the use of quantum Interference, and application of these nonlinearities to optical switches at low light levels (including the single-photon regime and quantum information processing).

### BACKGROUND OF THE INVENTION

Over the past years, a great deal of effort has gone into the search for a practical architecture for quantum computation. It is well known that single-photon optics provides a nearly ideal arena for many quantum-information applications; unfortunately, the absence of significant photon-photon (“nonlinear”) interactions at the quantum level appeared to limit the usefulness of quantum optics to applications in communications as opposed to computation. Therefore, work has focused on NMR, solid-state, and atomic-physics proposals for quantum logic gates, but so far none of these systems has demonstrated all of the desired features such as strong coherent interactions, low decoherence, and straightforward scalability. Typical optical nonlinearities are so small that the dimensionaless efficiency of photon-photon interactions rarely exceeds the order of a part in ten billion.

### SUMMARY OF THE INVENTION

The present invention shows that all optical switching (nonlinearity) may be enhanced by huge factors (e.g., ten orders of magnitude), making it possible for beams of light to control one another even in the extreme low-light-level regime (down to mean photon numbers smaller than 1). Such photon switches constitute novel quantum optical logic gates which may enable new technologies in quantum information processing as well as other low-light-level optical devices.

The present invention also provides a device which greatly enhances nonlinear optical effects between photon pairs in input laser beams via quantum interference. The device is capable of removing all (or nearly all) photon pairs from the input beams, efficiently converting them to their sum frequency. In an alternative mode, it is capable of changing the phase of all photon pairs in the input beams. The device thus functions as an all-optical switch which may be used as a quantum logic gate. The device can also be used to upconvert photon pairs of only particular polarizations, or to shift the phase of photon pairs of only particular polarizations, by using the appropriate choice of phase-matching. The device works even when there is, on average, less than one photon at a time in each input beam.

Broad Method

The method comprises having multiple (“pump” and “probe”) phase-related laser beams impinge on any optically nonlinear medium. One or more pump beam(s) have frequency, polarization, and direction chosen such that they are phase-matched to generate in the nonlinear medium probe beam(s) which are indistinguishable from the probe beams incident on the medium. Quantum interference occurs between the probes incident on the medium and those generated within the medium.

A Specific Method

Three phase-related beams are Incident on a crystal with a second order optical susceptibility ⁽²⁾. The crystal Is phase-matched such that the pump beam is capable of generating pairs of photons, at roughly one-half its frequency, in the probe beams. The sum of the phases of the two input probe beams is set to some difference from the phase of the pump. The medium acts as a conditional phase-switch for photons in the input beams. The photon pair term accumulates an extra, nonlinear, phase shift. The intensity of the two probe beams and the pump beam are fixed to a set ratio depending on the mode of operation. The probability of obtaining a down-converted photon pair is roughly the same (to within a few orders of magnitude) as the probability of obtaining a pair of photons from the input probe beams. The intensity of the pump can be changed to allow the switch to be operated In a low phase-shift mode or a high phase-shift mode.

### BRIEF DESCRIPTION OF THE DRAWINGS

Preferred embodiments of the invention will now be described, by way of example only, with reference to the drawings, in which:

FIG. 1 shows a diagrammatic representation of the present invention (a) Local oscillator (LO) beams (shown by dashed lines) are overlapped with the pair of down-converted beams. A coincidence count is registered either if (b) a down-conversion event occurs, or if (c) a pair of laser photons reaches the detectors (SPCMs).

FIG. 2 shows an experimental setup: BS1 and BS2 are 90/10 (T/R) beam splitters; SHG consists of two lenses and a BBO non-linear crystal for type-1 second-harmonis generation; BG is a colored glass filter; ND is a set of neutral density filters; A/2 is a zero-order half-wave plate; PH is a 25-m diameter circular pinhole; I.F. is a 10-nm-bandwidth interference filter, PBS is a polarizing beam splitter; and Det. A and Det. B are single photon counting modules. The thin solid line shows the beam path of the 810-nm light, and the heavy solid line the path of the 405-am pump light.

FIG. 3 shows the coincidence rate and singles rates as functions c the delay time. The coincidence counts (solid circles) demonstrate a phase-dependent enhancement or suppression of the photon pairs emitted from the crystal. The visibility of these fringe is (56.0 1.5)%. The corresponding effects in the singles rate at detectors A (open squares) and detector B (open diamonds) are also shown; the visibilities are 0.83% and 0.78%.

FIG. 4. The singles rate at detector A versus the delay for four different polarizer angle settings (labels in upper right corners). At −45o no LOs can pass; at 45o both LOs can pass; at 0o the LO to detector A can pass; at 90o the LO to detector B can pass. The fringes are apparent only for the +45o polarizer setting, and have a visibility of 0.7%. These four data sets show that both horizontally and vertically polarized photons must be present for the effect to occur.

Figures for Section II:

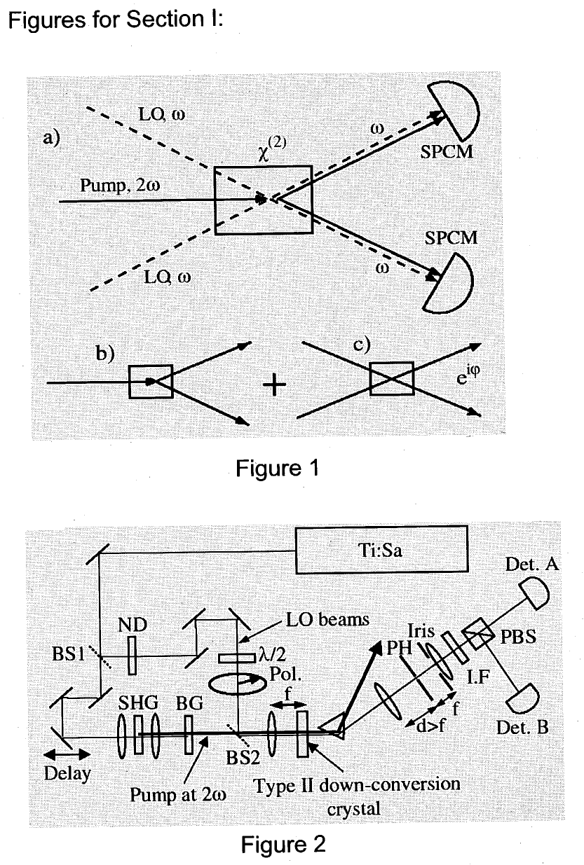

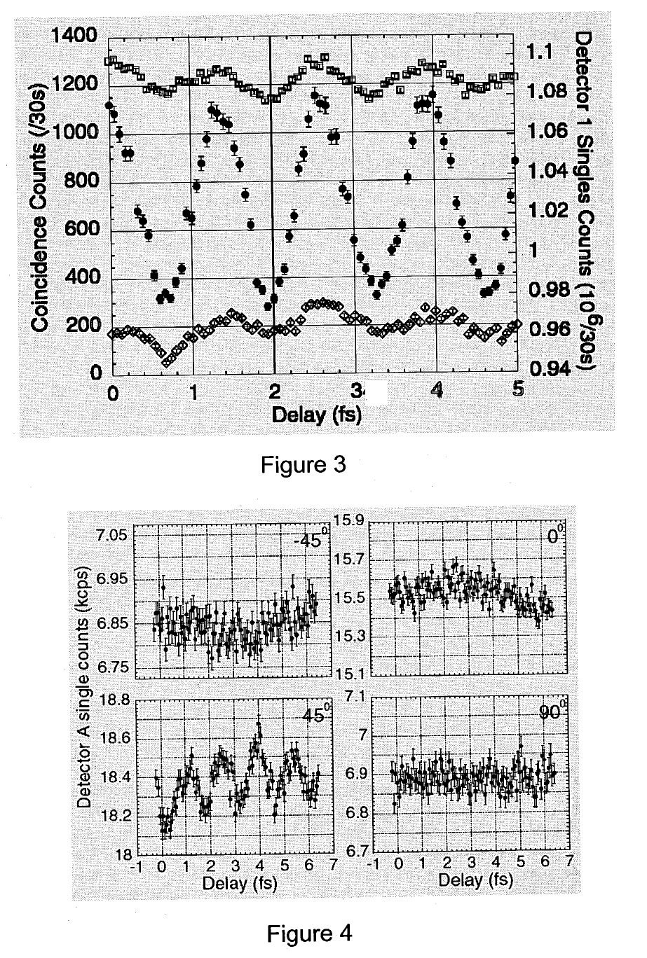

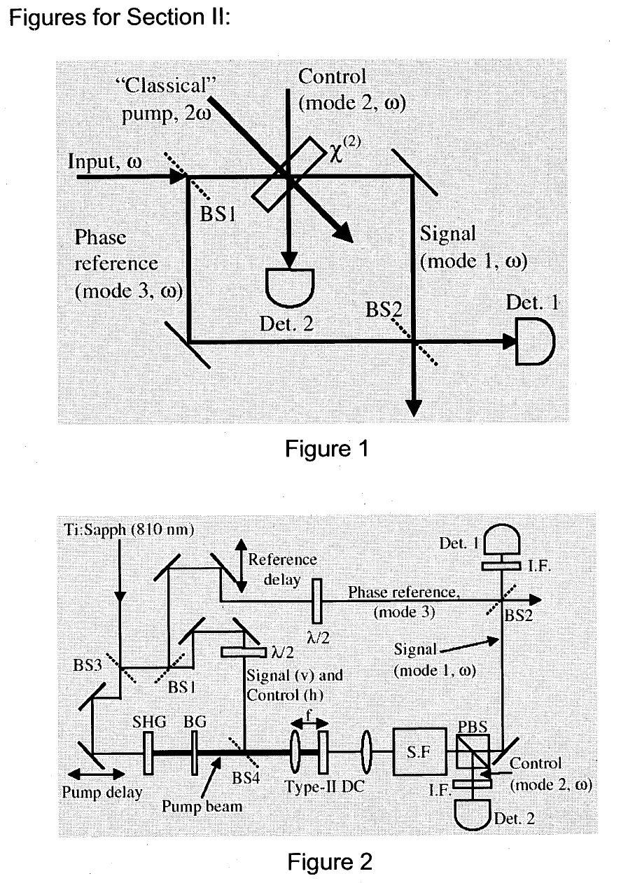

FIG. 1. A cartoon of the experiment. The signal beam, a weak (1) coherent state, is passed through a Mach-Zehnder interferometer in order to measure the phase shift. This shift is imprinted by a x(2) crystal pumped with a strong classical pump (p), only when the control beam (also a weak coherent state with mean photon number 2 1) contains a photon. This conditional phase operation is verified by correlating the MZ output fringes at det. 1 with detection of a control photon at det. 2.

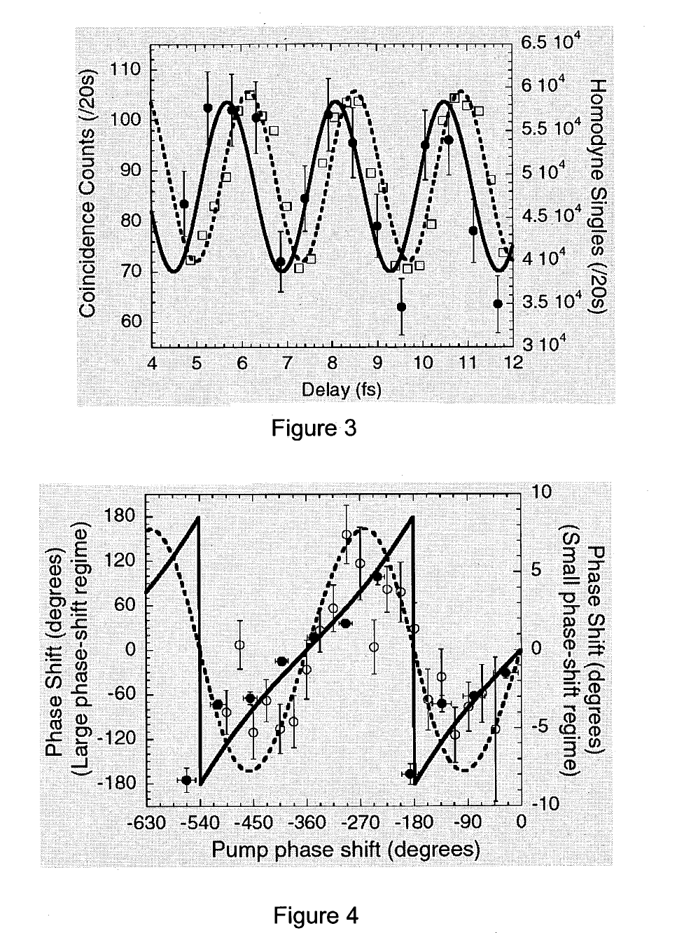

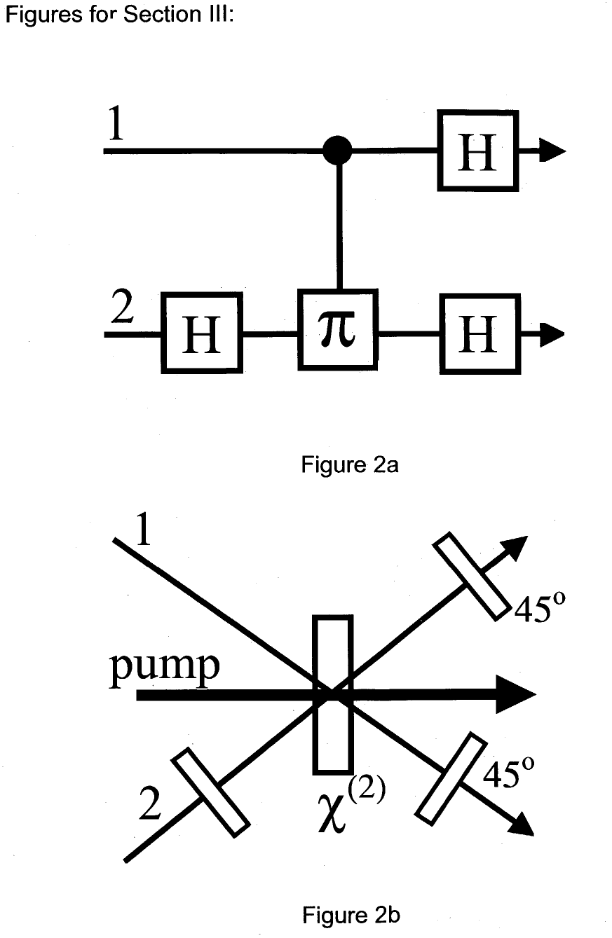

FIG. 2. Schematic of the experiment. BS 1-4 are 90/10 (T/R) beam splitters; SHG consists of two lenses and a 0.1-mm BBO crystal for type-1 second harmonic generation; A/2 are half-wave plates; S.F. is a spatial filter; I.F. are interference filters; BG is a blue filter; PBS is a polarizing beam splitter; det. 1 and 2 are photon counters. The pump laser at 405 nm is separated from the 810 nm light by using a fused-silica prism, not shown for clarity.

FIG. 3. Phase-shifted fringes in the large phase-shift regime. The det. 1 singles rate (open squares, dashed line) and coincidence rate between det. 1 and det. 2 (closed circles, solid line) are shown as a function of the reference delay. The coincidence fringes display the phase of the signal for cased in which a control photon was present; the singles are dominated by cases in which no photon was present. For this particular pump phase, the coincidence counting rate lags the singles rate by (65 8)°.

FIG. 4. Phase shift versus pump phase delay. The phase of the pump laser was changed via the pump delay and was estimated using the accompanying modulation in the mean coincidence rate [10]. The phase shift between the coincidence and singles fringes is plotted against the pump phase delay for both the large phase-shift regime (solid circles) and the small phase-shift regime (open circles). The solid and dashed lines show the theoretical predictions for these two cases, respectively, based only on the measured ratio of the individual-path rates, and with no adjustable parameters.

Figures for Section III:

FIG. 2. a) A quantum circuit and b) its optical analogue for the conversion of Bell states to product states. a) This quantum circuit takes a pair of qubits in input modes 1 and 2 and performs a unitary transformation that will convert a Bell state to a product state. b) The optical analogue of the quantum circuit takes a photon pair in a Bell state to a rectilinear product state, provided the photon pair is in the correct superposition with the vacuum.

### DETAILED DESCRIPTION OF THE INVENTION

I—Enhanced Second-Harmonic Generation (2-Photon Switch)

A. Background

Nonlinear effects in optics are typically limited to the high-intensity regime, due to the weak nonlinear response of even the best materials. An important exception occurs for resonantly enhanced nonlinearities, but these are restricted to narrow bandwidths. Nonlinear effects which are significant in the low-photon-number regime would open the door to a field of quantum nonlinear optics. This could lead to optical switches effective at the two-photon level (i.e., all-optical quantum logic gates), quantum solitons (e.g., two-photon bound states [1]), and a host of other phenomena. With this device, we demonstrate an effective two-photon nonlinearity mediated by a strong classical field. Quantum logic operations have already been performed in certain systems including trapped ions [2], NMR ([3], and cavity QED [4], but there may be advantages to performing such operations in an all-optical scheme—including scalability and relatively low decoherence. A few schemes have been proposed for producing the enormous nonlinear optical responses necessary to perform quantum logic at the single-photon level. Such schemes involve coherent atomic effects (slow light [5] and electromagnetically induced transparency [6] or photon exchange interactions [7]. We recently demonstrated that photodetection exhibits a strong two-photon nonlinearity [8], but this is not a coherent response, as it is connected to the amplification stage of measurement. While there has been considerable progress in these areas, coherent nonlinear optical effects have not yet been observed at the single-photon level for propagating beams. In a typical setup for the second-harmonic generation, for instance,a peak intensity on the order of 1 GW/cm² is required to provide an up-conversion efficiency on the order of 10%. In the device we describe here, beams with peak intensities on the order of 1 mW/cm² undergo a second-harmonic generation with an efficiency of about 1%, roughly 11 orders of magnitude higher than would be expected without any enhancement. While this 1% effect in the intensities of the outgoing modes can be described by a classical nonlinear optical theory, the underlying origin of the effect is observable in the correlations of the outgoing modes and requires a quantum mechanical explanation. Furthermore, the effect in the correlations produced by this device was measured to be about 70 times larger than in the intensities and, in theory, 100% of the photon pairs can be up-converted.

B. Enhanced Two-Photon Absorption/Suppressed Two-Photon Transmission

Our device relies on the process of spontaneous parametric down-conversion. If a strong laser beam with a frequency 2ω passes through a material with a nonzero second-order susceptibility, x⁽²⁾, then pairs of photons with nearly degenerate frequencies, v, can be created. In past experiments, interference phenomena have been observed between weak classical beams and down-converted photon pairs [9-11]. Although spontaneously downconverted beams have no well-defined phase (and therefore do not display first-order interference), the sum of the phases of the two beams is fixed by the phase of the pump. Koashi et al. [10] observed this phase relationship experimentally using a local oscillator (LO) harmonically related to the pump. More recently Kuzmich et al. [11] performed homodyne measurements to directly demonstrate the anticorrelation of the down-converted beams' phases. Some proposals for tests of nonlocality [12] have relied on the same sort of effects. Such experiments involve beating the down-converted light against a local oscillator at one or more beam splitters, and hence have multiple output ports. The interference causes the photon correlations to shift among the various output ports of the beam splitters.

In contrast, with this device the actual photon-pair production rate is modulated. A simplified cartoon schematic of our device is shown in FIG. 1. A nonlinear crystal is pumped by a strong classical field, creating pairs of down-converted photons in two distinct modes (solid lines). Local oscillator beams are superposed on top of the down-conversion modes through the nonlinear crystal and are shown as dashed lines. A single-photon counting module (SPCM) is placed in the path of each mode. To lowest order there are two Feynman paths that can lead to both detectors firing at the same time (a coincidence event). A coincidence count can occur either from a downconversion event (FIG. 1b), or from a pair of LO photons (FIG. 1c). Interference occurs between these two possible paths provided they are indistinguishable. Depending on the phase difference between these two paths (φ) we observe enhancement or suppression of the coincidence rate. A phase-dependent rate of photon-pair production has been observed in a previous experiment using two pairs of down-converted beams from the same crystal [13]. By contrast, our device uses two independent LO fields which can be from classical or quantum sources and subject to external control. If the phase between the paths (FIGS. 1b, 1c) is chosen such that coincidences are eliminated, then photon pairs are removed from the LO beams by up-conversion into the pump mode. If, however if one of the LO beams is blocked, then those photons that would have been up-converted are now transmitted through the crystal. This constitutes an optical switch in which the presence of one LO field controls the transmission of the other LO field, even when there is less than one photon in the crystal at a time. This switch does have certain limitations. First, it is inherently noisy because it relies on spontaneous down-conversion, which leads to coincidences even if one or both of the LO beams are blocked. Second, since the switch relies on interference, and hence phase, it does not occur between photon pairs but between the amplitudes to have a photon pair. While this may limit the usefulness of the effect as the basis of a “photon transistor,” a simple extension should allow it to be used for conditional-phase operations (see Section II).

In order for the down-conversion beams to interfere with the laser beams, they must be indistinguishable in all ways (including frequency, time, spatial mode, and polarization). Down-conversion is inherently broadband and exhibits strong temporal correlations; the LOs must therefore consist of broadband pulses as well. We use a mode locked Ti:sapphire laser operating with a central wavelength of 810 nm (FIG. 2). It produces 50-fs pulses at a rate of 80 MHz. This produces the LO beams, and its second harmonic serves as the pump for the down-conversion. Thus, the down-conversion is centered at the same frequency as the LO, and the LOs and the down-converted beams have similar bandwidths of around 30 nm. To further improve the frequency overlap, we frequency postselect the beams using a narrow bandpass (10 nm) interference filter [14]. As this is narrower than the bandwidth of the pump, it erases any frequency correlations between the down-conversion beams. In addition to spectral indistinguishability, the two light sources must possess spatial indistinguishability. The down-conversion beams contain strong spatial correlations between the correlated photon pairs; measurement of a photon in one beam yields some information about the photon in the other beam. Such information does not exist within a laser beam; since there is only a single transverse mode, the photons must effectively be in a product state and exhibit no correlations. We therefore we select a single spatial mode of the down-converted light by employing a simple spatial filter. The beams are focused onto a 25 micron diameter circular pinhole. The light that passes through the pinhole and a 2-mm diameter iris placed 5 cm downstream is collimated using a 5-cm lens. In order to increase the flux of down-converted photons into this spatial mode, we used a pump focusing technique related to the one demonstrated by Monken et al. [15]. The pump laser was focused directly onto the down-conversion crystal. Since the coherence area of the down-converted beams is set by the phase-matching acceptance angle, the smallest pump area reduced the number of spatial modes being generated at the crystal, improving the efficiency of selection in a single mode. Imaging the small illuminated spot of our crystal onto the pinhole, we were able to improve the coincidence rate after the spatial filter by a factor of 30.

The final condition necessary to obtain interference is to have a well-defined phase relationship between the LO beams and the down-conversion beams. To achieve this, the same Ti:sapphire source laser is split into two different paths (FIG. 2). The majority of the laser power (90%) is transmitted through BS1 into path 1, where it is type-I frequency doubled to produce the strong (approximately 10-mW) classical pump beam with a central frequency of 405 nm. This beam is used to pump our down-conversion crystal after the 810-nm fundamental light is removed by colored glass filters. Instead of using down-conversion with spatially separate modes as shown in FIG. 1, we use type-II down-conversion from a 0.5-mm beta-barium borate (BBO) nonlinear crystal. In this process, the photon pairs are emitted in the same direction but with distinct polarizations. The photon pairs are subsequently spatially filtered, spectrally filtered, and then split up by the polarizing beam splitter (PBS). The horizontally polarized photon is transmitted to detector A, and the vertically polarized photon is reflected to detector B. Detectors A and B are both single-photon counting modules (EG&G models SPCM-AQ-131 and SPCM-AQR-13). Path 1 also contains a trombone delay arm which can be displaced to change the relative phase between paths 1 and 2. To create the LO laser beams, we use the 10% reflection from BS1 into path 2. The vertically polarized laser light is attenuated to the single-photon level by a set of neutral-density (ND) filters, and its polarization is then rotated by 45° using a zero-order half-wave plate, so that it serves simultaneously as LO for the horizontal and vertical beams. After the wave plate, the light may pass through a polarizer, which can be used to block one or both of the polarizations from this path. This is equivalent to blocking one or both of the LO beams. Ten percent of the light from path 2 is superposed with the down-conversion pump from path 1 at BS2. The LO beams are thus subject to the same spatial and spectral filtering as the down-conversion and are separated by their polarizations at the PBS. This setup is similar to certain experiments investigating two-mode squeezed light [16]. Rater than investigate the noise characteristics of the output modes, we study the effect of a photon in one LO beam on the transmission of a photon in the other beam.

In order to maximize the interference visibility, we chose the ND filters so that the coincidence rate from the downconversion path was equal to the coincidence rate from the laser path. The singles rates from the down-conversion path alone were 830/s and 620/s for detectors A and B, respectively, and the coincidence rate was (110±0.3)/s (the ambient background rates of roughly 340/s for detector A and 540/s for detector B have been subtracted from the singles rates, but no background subtraction is performed for the coincidences). The singles rates from the LO paths were 34 560 and 31 350/s for detectors A and B, respectively, and the coincidence rate from this path is (11.6±0.4)/s. The LO intensities need to be much higher than the down-conversion intensities to achieve the same rate of coincidences because the photons in the LO beams are uncorrelated. Nonetheless, the mean number of LO photons per pulse is on the order of 0.01 at the crystal and for this reason the process of stimulated emission is negligible. As the trombone arm was moved to change the optical delay, we observed a modulation in the coincidence rate (FIG. 3). We have explained that this interference effect leads to enhancement or suppression of photon-pair production; naturally, this should be accompanied by a modification of the total photon number, i.e., the intensity reaching the detectors. The visibility of the coincidence fringes is (56.0±1.5)% , and the visibilities in the singles rates are approximately 0.83% and 0.78% for detectors A and B, respectively. In theory, the visibility in coincidences asymptotically approaches 100% in the very weak beam limit for balanced coincidence rates. At the peak of this fringe pattern, the total rate of photon pair production is greater than the sum of the rates from the independent paths. At the valley of the fringe pattern, the rate of the photon-pair production is similarly suppressed. With appropriate device parameters, we have observed coincidence rates drop 16% below the rate from the laser beams alone, an 8 sigma effect. The coincidence and singles fringes are all in phase and have a period corresponding to the 405-nm pump laser. To ensure that the observed oscillations in the coincidence rate were not due to a spurious classical interference effect, we verified that interference was destroyed by insertion of either a blue filter in the LO path or a red filter in the pump laser path, but unaffected by red filters in the LO path or blue filters in the pump path.

FIG. 4 shows four sets of singles rate data for detector A, corresponding to four different polarizer settings. Recall that the light is incident upon the polarizer at 45°, so when the polarizer is set to 45°, both of the LO beams are free to pass. When the polarizer is set to 0° or 90°, one of the LO beams is blocked, and when the polarizer is set to −45° both of the LO beams are blocked. The left-hand side of FIG. 4 shows the data for the two orthogonal diagonal settings of the polarizer, −45° (top panel) and 45° (bottom panel); the right-hand side shows the data for the two orthogonal rectilinear settings, 0° (top panel) and 90° (bottom panel). When the polarizer is set to 0°, only the LO going to detector A is allowed to pass; on the other hand, when it is set to 90°, only the LO going to detector B is allowed to pass, so A measures only background plus down-conversion. For the 45° data, the singles rate at detector A shows fringes with a visibility of about 0.7%. This visibility is roughly 70 times smaller than the corresponding visibility in the coincidence rate because only about 1.4% of detected photons are members of a pair, due to the classical nature of our LO beams. The fringe spacing in the singles rate corresponds to that of the pump laser light at 405 nm even though it is the 810-nm intensity that is being monitored. By examining the other three polarizer settings (−45°, 0°, and 90°), it is apparent that in order to observe fringes in the singles rate, both LO paths must be open. This is evidence for a nonlinear effect of one polarization mode on another.

C. Photon Correlation (The Switch)

The intensity (singles rates) fringes can be explained by a classical nonlinear optical theory. Although the intensity of the difference-frequency light generated by one LO beam and the pump is negligibly small, its amplitude beats against the other LO to produce a measurable effect in analogy with optical homodyning. However, in a classical picture, the coincidence rate is just proportional to the product of the two singles rates [17]. Therefore, the maximum visibility in the coincidences in a classical theory is just the sum of the visibilities in the singles rates. In out case, that would correspond to a coincidence visibility of only 1.6%. Our 56% visibility can be explained only by a quantum mechanical picture in which the probability for one photon to reach a detector is strongly affected by the presence or absence of a photon in the other beam. A theoretical description of the intensity and coincidence effects has been performed. We have demonstrated a quantum interference effect which is an effective nonlinearity at the single-photon level. We have shown that pairs of photons may be removed from two LO beams, although the system is transparent to individual photons. The phenomenon is closely analogous to second-harmonic generation in traditional nonlinear materials, but is enhanced by the simultaneous presence of a strong classical spectator beam with an appropriately chosen phase. For a different choice of phase, it is be possible to observe an effect analogous to cross-phase modulation between the two weak modes (see section II). Strong nonlinearities at the single-photon level should be widely applicable in quantum optics [19,20]. Overall, effects such as these hold great promise for extending the field of nonlinear optics into the quantum domain.

References

[1] R. Y. Chiao et al., Phys, Rev. Lett. 67, 1399 (1991); I. H. Deutsch et al., Phys. Rev. Lett. 69, 3627 (1992).

[2] C. Monroe et al., Phys. Rev. Lett. 75, 4714 (1995).

[3] N. A. Gershenfeld and I. L. Chuang, Science 275, 350 (1997); J. A. Jones and M. Mosca, Phys. Rev. Lett. 83, 1050 (1999); J. A. Jones et al., Nature (London) 393, 344 (1998); D. G. Cory et al., Phys. Rev. Lett. 81, 2152 (1998).

[4] Q. A. Turchette et al., Phys. Rev. Lett. 75, 4710 (1995); G. Nogues et al., Nature (London) 400, 239 (1999).

[5] L. V. Hau et al., Nature (London) 397, 594 (1999); M. M. Kash et al., Phys. Rev. Lett. 82, 5229 (1999); S. E. Harris and L. V. Hau, Phys. Rev. Lett. 82, 4611 (1999); A. Kasapi et al., Phys. Rev. Lett. 74, 2447 (1995).

[6] S. E. Harris et al., Phys. Rev. Lett. 64, 1107 (1990); M. Jain et al., Phys. Rev. Lett. 77,4326 (1996); M. D. Lukin et al., Phys, Rev. Lett. 81, 2675 (1998); for a review, see S. E. Harris, Phys. Today 50, No. 7, 36 (1997).

[7] J. D. Franson and T. B. Pittman, Phys. Rev. A 60, 917 (1999).

[8] K. J. Resch et al., Phys. Rev. A 63, 020102(R) (2001).

([9] J. G. Rarity et al., quant-ph/9702032.

[10] K. Koashi et al., Phys. Rev. A 50, R3605 (1994).

[11] A. Kuzmich et al., Phys. Rev. Lett. 85, 1349 (2000).

[12] L. Hardy, Phys. Rev. Lett. 73, 2279 (1994).

[13] T. J. Herzog et al., Phys. Rev. Lett. 72, 629 (1994); H. Weinfurter et al., Ann. N.Y. Acad. Sci. 755, 61 (1995).

[14] G. Di Giuseppe et al., Phys. Rev. A 56, R21 (1997).

[15] C. H. Monken et al., Phys. Rev. A 57, R2267 (1998).

[16] P. D. Townsend and R. Loudon, Phys. Rev. A 45, 458 (1992); C. Kim et al., Opt. Lett. 19, 132 (1994).

[17] R. J. Glauber, in Quantum Optics and Electronics, edited by C. DeWitt et al. (Gordon and Breach, New York, 1965), pp. 63-185.

[19] N. Lütkenhaus et al., Phys. Rev. A 59, 3295 (1999).

[20] Y-H. Kim et al., Phys. Rev. Lett. 86, 1370 (2001).

II—Conditional-Phase Switch for Photons

A. Background

A great deal of effort has gone into the search for a practical architecture for quantum computation. As was recognized early on, single-photon optics provides a nearly ideal arena for many quantum-information applications [1]; unfortunately the absence of significant nonlinear effects at the quantum level (photon-photon interactions) appeared to limit the usefulness of quantum optics to applications in communications as opposed to computation. (Nevertheless, two recent proposals [2,3] have resurrected the possibility of quantum computation using purely linear optics.) Therefore, work has focused on NMR, [4], solid-state [5], and atomic [6-9] proposals for quantum logic gates, but so far none of these systems has demonstrated all of the desired features such as strong coherent interactions, low decoherence, and straightforward scalability. Typical optical nonlinearities are so small that the dimensionless efficiency of photon-photon interactions rarely exceeds the order of 10⁻¹⁰. We have recently used quantum interference to enhance these nonlinearities by as much as 10 orders of magnitude, leading to near-unit-efficiency sum-frequency generation of individual photon pairs. In this application, we demonstrate that a similar geometry can be used to make a conditional phase switch. Our switch is very similar to an enhanced Kerr or cross-phase-modulation effect, in which the presence or absence of a single photon in one mode may lead to a significant phase shift of the other mode. This is also similar to experiments performed in cavity QED [6] (and to theoretical proposals for atomic vapors, in systems relying on atomic coherence effects [11] or photon exchange interactions [12]), but occurs in a relatively simple and robust system relying only on beams interacting in a nonresonant nonlinear crystal.

The controlled-phase or c-φ gate performs the mapping |m>₁|n>₂−>exp(imnφ)|m>₁|n>₂, where the subscripts 1 and 2 indicate the two qubits, stored in two distinct optical modes, and m and n can take the values 0 and 1 representing zero- and one-photon states [13]. This shifts the phase of |1>₁|1>₂ by φ, leaving the other three basis states unchanged. Although in quantum mechanics an overall phase factor is meaningless, this unitary transformation is nontrivial when we consider what happens to superpositions of photon number. The operation induces a relative phase of f between the |0> and |1> states of qubit 2, if and only if qubit 1 is in state |1>. (It is this relative phase which is referred to as the “optical phase” of mode 2 [14].)

B. The Device

Since our device relies on interference, its operation is sensitive to the phase and amplitude of the initial state, and we must limit ourselves to a specific set of inputs. In particular, we illuminate our switch with two classical fields in weak coherent states, |Psi>=|a>|b>=[|0>₁+a|1>₁] [|0>₂+b|1>₂], for |a| and |b|<<1 This state includes contributions of all four two-qubit computational basis states. As we show theoretically and experimentally, the lowest-order action of the gate is to shift the phase of only the |1>₁|1>₂ state, as desired for c-φ operation.

This gate differs from the canonical c-φ concept in several regards. Principally, the input cannot be in a pure Fock state (e.g., |1>₁|1>₂), or an arbitrary superposition of the computational-basis states, because the appropriate relative phase of |0>₁|0>₂ and |1>₁|1>₂ must be chosen at the outset. Nevertheless, the gate produces significant entanglement at the output and may be useful in nondeterministic operation [2]; in other words, it may be possible to postselect the desired value of a given qubit rather than supplying it at the input. Alternatively, such a gate might be used in the polarization rather than the photon-number basis. The interaction can be controlled through phase-matching conditions such that the phase shift is impressed only if both photons have, for example, vertical polarization. Thus, two-photon entangled states as typically produced in down-conversion systems, which are more properly described as |Psi>=|0>₁|0>₂+epsilon {w|H>|H>+x|H>|V>+y|V>|H>+z|V>|V>}, could store the amplitudes of the four computational-basis states in the amplitudes w, x, y, and z, with the (small) coefficient epsilon ensuring that epsilon*d exhibits the appropriate phase relationship with the vacuum. Although the vacuum term would dominate, as in most down-conversion experiments, the computation would have the desired effect contingent simply on the eventual detection of a photon pair. Potential contamination due to states outside the computational basis (e.g., states in which two photons are present in the same mode) can be avoided by operating in the low-photon-number regime. Finally, the question as to whether the entanglement produced by these interactions might be useful as a generalized quantum gate in some larger Hilbert space (e.g., higher photon number states) remains open.

C. Implementation

Our device can be described as a modified Mach- Zehnder interferometer (MZI) (FIG. 1). The input beam is a weak laser pulse of frequency v (containing much less than one photon per pulse on average) which enters the interferometer and is split into the signal (mode 1) and phase reference (mode 3). Modes 1 and 3 are recombined at a beam splitter after mode 1 passes through a x⁽²⁾ nonlinear crystal which is simultaneously illuminated by a pump beam at frequency 2v. The output fringes from the MZI serve to measure the relative phase introduced between the two arms by the action of the crystal. Our control beam (mode 2) is another very weak coherent state at v that crosses mode 1 inside the nonlinear crystal. Photon-counting detectors monitor one output of the interferometer and mode 2. In order to demonstrate the conditional phase operation of the device, we measure the phase of the fringes at det. 1 and compare the cases in which the control detector (det. 2) does or does not fire. This “conditional homodyne” measurement is similar to recent studies of “wave-particle correlations” in cavity QED [16].

A more detailed schematic of the device is shown in FIG. 2. The beam from a Ti:sapphire oscillator (center wavelength 810 nm, rep rate 80 MHz, and pulse duration 50 fs is used to create the four beams used in the device. The phase reference, signal, and control beams are created by separating a small amount of the fundamental beam with beam splitters (BS) 3 and 1—all beam splitters are 90/10 (T/R). The signal and control beams are made by rotating the polarization after BS1 and treating the horizontal and vertical components independently. All three of these beams are subsequently attenuated using neutral density filters. The majority of the pump undergoes second-harmonic generation (SHG) in a type-I beta-barium borate (BBO) crystal. With the fundamental removed, this 405-nm pulse serves as the pump laser for parametric down-conversion. The signal and control beams are recombined with the pump laser at BS4 and all three beams are focused onto a second 0.5-mm BBO crystal phase matched for type-II down-conversion and, therefore, type-II SHG. The spot created on the down-conversion crystal is imaged through a spatial filter to select a single spatial mode. The output from the spatial filter is separated by a polarizing beam splitter (PBS) such that the vertically polarized control beam is sent to detector 2 for direct photodetection, while the horizontally polarized signal beam interferes with the phase reference at BS 2. Detector 1 measures the output from one port of BS 2. Both detectors are silicon avalanche photodiodes. Interference filters, with center wavelengths of 810 nm and bandwidths of 10 nm, are placed in front of each detector.

In previous work, described in section I, we demonstrated that quantum interference leads to a phase-sensitive photon-pair production rate in a similar geometry. The interference can be understood as follows. Initially, modes 1 and 2 contain weak coherent states and mode p contains an intense (classical) pump laser: |Psi>=|p>ₚ[|00>+a|10>+b|01>+ab|11>]. Under the interaction Hamiltonian, Hᵢₙₜ of the nonlinear crystal, the lowest order action of the pump laser is simply to add an amplitude for a photon pair through parametric down-conversion. The final state becomes |Psi>=|p>ₚ[|00>+a|10>+b|01>+(ab+A_{DC})|11>], where A_{DC} is the amplitude for downconverion. In the verication of the device described in section I, we observed the modulation in the photon pair production rate by performing direct photon coincidence counting on modes 1 and 2. We changed the phase of the amplitude A_{DC} by changing the delay of the pump laser and, in so doing, changed the value of |ab+A_{DC|}²—the probability of producing a photon pair. However, this process also affects the phase of that amplitude, i.e., arg(ab+A_{DC}), This is the “cross-phase modulation” we study. The absolute phase of a state is never experimentally observable; we therefore study the relative phase between |11> and |01>, contrasting it with the case of no control photon: |10> vs |00>. This relative phase is precisely the optical phase measured by our Mach-Zehnder interferometer. The final state of modes 1 and 2 can be rewritten as follows: |Psi>=(|0>₁+a |1>₁)|0>₂+b[|0>₁+(a+(A_{DC}/b)|1>₁]|1>₂]. In this form, it is evident that entanglement is generated between the photon number in mode 2 and the optical phase in mode 1; the conditions that |a|, |b|<<1 limit the state to one of nonmaximal entanglement. Nonetheless, maximal entanglement can be produced in polarization within the coincidence subspace. When |A_{DC}|<<|ab|, (i.e., the down-conversion rate is much less than the “accidental” coincidence rate from the signal and control change in rate. In the opposite limit, when |A_{DC}|>|ab|, the maximum phase shift is 180° and occurs at the point of maximum destructive interference.

To explore the small phase-shift regime, we adjusted our signal and control beam intensities to obtain, in the absence of interference, a coincidence rate of (256±3)/s between det. 1 and det. 2. Our coincidence rate from downconversion alone was (4.7±0.2)/s. The singles rates at det. 1 (again in the absence of interference) were 88×10³/s from the signal beam alone and 79×10³/s from the phase reference; det. 2 received a singles rate of 282×10³/s from the control beam. This corresponds to several photons per thousand laser pulses. The singles rates due to down-conversion were 400/s at det. 1 and 300/s at det. 2. To demonstrate the device, the phase reference was blocked and pump delay moved in subwavelength steps to observe fringes in the photon pair production rate (described in [10]). The pump delay was then stopped at a fixed phase relative to the maximum of the pair-production fringes. We then scanned over a few Mach-Zehnder interference fringes by stepping the reference delay in 0.04-micron steps and recorded the singles rates at the two detectors and their coincidence rate. Because of the low probability of having a photon in any given control pulse, the interference fringes in det. 1's singles rate are dominated by the case where zero photons are present in the control mode; the coincidence rate shows the phase-shifted fringes when a control photon is detected.

A sample data set is shown in FIG. 3 for a pump delay of −1.6 fs (about −455°). For clarity, the fringes shown are taken in the large phase-shift regime, with |A_{DC}>|ab|. To achieve this regime, we reduced our coincidence rate from the signal and control beams to (1.1±0.1)/s in the absence of interference; our down-conversion coincidence rate was (5.2±0.2)/s. Det. 1 received about a 700/s singles rate from the signal and 8600/s from the phase reference, det. 2 had a singles rate of 129×10³/s from the control beam. The coincidence counts have been averaged over 40-sec intervals due to the considerable shot noise. The fringes were fitted to cosine curves where the period of the coincidence fringes was constrained to equal that of the singles fringes. The phase difference was then extracted modulo 360°.

D. Verification of Gate Operation

Relative phases were measured in this way for many different pump phase delays; those values are summarized in FIG. 4. The phase shifts measured for the low phase-shift regime are the open circles (right-hand scale). The dashed line is the theoretical prediction based on the experimentally observed ratio of coincidence rates, with no adjustable parameters. In this regime, the phase shift is limited to approximately |A_{DC}|/|ab| about 8° for the experimental ratio of coincidence rates. The phase shift is approximately sinusoidal in the pump phase for this ratio. The shifts in the large phase-shift regime are shown in FIG. 4 as solid circles (left-hand scale). Theory is shown as a solid line and, again, involves no free parameters. It is clear that in this regime we are able to access any phase shift. In this regime, the phase shift does not follow a sinusoidal modulation but rather increases monotonically with the pump phase, modulo 360°. There is strong agreement between theory and experiment, with slightly reduced phase shifts in the low phase-shift regime possibly attributable to background.

We have demonstrated the correlation between the photon number in one mode and the optical phase in another in a coherent conditional phase switch. Our theoretical description of the device shows that entanglement between the two modes is generated, but explicit demonstration requires additional measurements. This is a new type of asymmetric entanglement, of the sort required for the quantum c-φ gate. However, our switch differs from the c-φ, since the switch's reliance on quantum interference makes it intrinsically dependent on the optical phase of the input beams While this phase dependence will not allow the gate to operate on Fock states, the gate does act exactly as a c-φ in the coincidence basis in some interesting situations. Devices such as this for of creating and controlling entanglement at the single-photon level are very exciting for the field of nonlinear quantum optics and are promising steps towards all-optical quantum computing.

References

[1] C. H. Bennett and G. Brassard, in Proceedings of the IEEE International Conference on Computers, Systems & Signal Processing, Bangalore, India (IEEE, New York, 1984), pp. 175-179; A. K Ekert, J. G. Rarity, and P. P. Tapster, Phys. Rev. Lett. 69, 1293 (1992); A. Muller, J. Breguet, and N. Gisin, Europhys. Lett. 23, 383 (1993); W. T. Buttler et al., Phys. Rev. Lett. 81, 3283 (1998); C. H. Bennett et al., Phys. Rev. Lett. 70, 1895 (1993); D. Bouwmeester et al., Nature (London) 390, 575 (1997). [2] E. Knill, R. Laflamme, and G. Milburn, Nature (London) 409, 46 (2001).

[3] D. Gottesman, A. Kitaev, and J. Preskill, Phys. Rev, A 64, 012310 (2001).

[4] N. A. Gershenfeld and I. A. Chuang, Science 275, 350 (1997); J. A. Jones, M. Mosca, and R. H. Hansen, Nature (London) 393, 344 (1998); D. G. Cory et al., Phys. Rev. Lett, 81, 2152 (1998).

[5] B. E. Kane, Nature (London) 393, 133 (1998).

[6] Q. A. Turchette et al., Phys. Rev. Lett. 75, 4710 (1995); A. Rauschenbeutel et al., Phys. Rev. Lett. 83, 5166 (1999).

[7] G. Nogues et al., Nature (London) 400, 239 (1999); P. W. H. Pinkse et al., Nature (London) 404, 365 (2000).

[8] J. I. Cirac and P. Zoller, Phys. Rev. Lett. 74, 4091 (1995); A. Sørensen and K. Mølmer, Phys. Rev. Lett. 82, 1971 (1999); C. Monroe et al., Phys. Rev. Lett. 75, 4714 (1995).

[9] G. K. Brennen et al., Phys. Rev. Lett. 82, 1060 (1999); D. Jaksch et al., Phys. Rev. Lett. 85, 2208 (2000).

[11] S. E. Harris and L. V. Hau, Phys. Rev. Lett. 82, 4611 (1999); M. M. Kash et al., Phys. Rev. Lett. 82, 5229 (1999).

[12] J. D. Franson, Phys. Rev. Lett. 78, 3852 (1997).

[13] M. A. Nielsen and I. L. Chuang, Quantum Computation and Quantum Information (Cambridge University Press, Cambridge, 2000), p. 294.

[14] R. Loudon, The Quantum Theory of Light (Clarendon Press, Oxford, 1973), 2nd ed., pp. 141-144; J. W. Noh, A. Fougères, and L. Mandel, Phys. Rev. Lett. 67,1426 (1991).

[16] G. T. Foster et al., Phys. Rev. Lett. 85, 3149 (2000).

III—Quantum Logic (Bell-State Determination)

A. Background

The new science of quantum information builds on the recognition that entanglement, an essential but long underemphasized feature of quantum mechanics, can be a valuable resource. Many of the headline-grabbing quantum communication schemes (including quantum teleportation, dense coding, and quantum cryptography) are based on the maximally-entangled two-particle quantum states called Bell states. Using the polarization states of a pair of photons in different spatial modes, the four Bell states are written as: |φ^{±}>=|HH>±|VV> and |ψ^{±}>=|HV>±|VH>, where |H> and |V> describe horizontal- and vertical-polarization states. These four states form a complete, orthonormal basis for the polarization states of a pair of photons. In each Bell state, a given photon is completely unpolarized but perfectly correlated with the polarization of the other photon. Photon Bell states were produced in atomic cascades for the first tests of the nonlocal predictions of quantum mechanics. Since that time, parametric down-conversion sources have replaced cascade souces due to their ease of use, high brightness, and the high-purity states they produce. However, down-conversion sources do not deterministically prepare photon Bell states, but rather states in which the Bell state component is in a coherent superposition with a dominant vacuum term; coincidence detection of photon pairs projects out only the two-photon component of the state.

B. Application of the Device

While optical Bell state source technology has shown marked improvement, methods of distinguishing these states has proven a difficult challenge. Perhaps the most well-known example of why distinguishing Bell states is important comes from quantum teleportation. A general projective measurement is required for unconditional teleportation; experimental teleportation was originally limited to a maximum efficiency of 25% since only the singlet state, |ψ>, could be distinguished from the other three states. The challenge for distinguishing Bell-states stems from the requirement for a strong inter-particle interaction, which is usually nonexistent for photons. Without such a nonlinearity, only two of the four states can be distinguished. It was realized that a strong enough optical nonlinearity, typically a x⁽³⁾ nonlinearity, could be used to mediate a photon-photon interaction. Unfortunately, even the nonlinearities of the best materials are far too weak. An experiment using standard nonlinear materials to demonstrate a scheme for unconditional teleportation was limited to extremely low efficiencies (on the order of 10⁻¹⁰). Proposals for extending optical nonlinearities to the quantum level include schemes based on cavity QED, electomagactically-induced transparency, photon-exchange interactions, and quantum interference techniques. Using the latter, we have recently demonstrated a conditional-phase switch, which is similar to the controlled-phase gate in quantum computation (discussed in section II).

Strong optical nonlinearities are desired so that one can construct a controlled-φ, a specific case of the controlled-phase gate for photons. Such a gate and all one-qubit rotations form a universal set of gates for the more general problem of quantum computation just as the NAND gate is universal for classical computation. One-qubit rotations are simple and easy to perform on photons. Consequently, with our conditional-phase switch one can construct a gate that transforms each Bell-state into a different logical basis state of a two-qubit system. Application of the latter gate and measurement in the logical basis performs a Bell-state measurement. The only unique requirement of this Bell-state measurement the photon pairs are in a known coherent superposition with the vacuum. This follows from the requirements for a functional conditional-phase switch, discussed in section II.

We disclose a way of implementing a transformation capable of converting the polarization state of a pair of photons from the rectilinear basis to the Bell state basis and vice versa provided the photon pairs are in a known coherent superposition with the vacuum. This transformation relies on a recently reported effective nonlinearity at the single-photon level. Requiring the photon pair to be in a superposition with the vacuum seems unusual, but this type of superposition exists in all down-conversion sources of entangled photons. It is only upon performing a photon-counting coincidence measurement that the maximally-entangled behaviour is projected out. While these down-conversion sources of Bell states exist and are practical in the lab, the creation mechanism does not suggest how one might try to measure those Bell states. In the device discussed here, the Bell state creator and Bell state analyzer look very similar. The creator can essentially be run in reverse to make the analyzer.

The device discussed herein constitutes a novel way of manipulating the degree of entanglement between a pair of photons, and may find a use in other quantum optics applications. In particular, it can be used for dense coding [1,2] a method of communicating more than one bit of information on a single photon. The ability to entangle and disentangle photon pairs is a crucial step toward building scalable all-optical quantum computers.

As used herein, the terms “comprises” and “comprising” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### Appendices Forming Part of the Present Disclosure

The appendix attached hereto provides mathematical material forming part of the present invention.

Practical creation and detection of polarization Bell states using parametric down-conversion, K. J. Resch, J. S. Lundeen, and. A. M. Steinberg. To be published in the Solvay Conference Proceedings (2002).

Electromagnetically induced opacity for photon pairs, K. J. Resch, J. S. Lundeen, and A. M. Steinberg, Journal of Modern Optics, 49,487 (2002).

References

[1] C. H. Bennett and S. J. Wiesner, “Communication via one- and two-particle operators on Einstein-Podolsky-Rosen states,” Phys. Rev. Lett. 69, 2881 (1992)

[2] K. Mattle, H. Weinfurter, P. Kwiat, and A. Zeilinger, “Dense Coding in Experimental Quantum Communication,” Phys. Rev. Lett. 76, 4656 (1996).

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Therefore what is claimed is:

1. A device for optical switching, comprising:
means for generating multiple pump and signal laser beams impinge on an optically nonlinear medium in such a way so that quantum interference occurs between the input pump fields and the fields generated by the nonlinearity, said interference sum giving rise to greatly enhanced effective nonlinearities.

2. The device according to claim 1 is capable of upconverting most or all photon pairs in the input beams (ie. turning each photon pair in a single photon at the sum frequency).

3. The device according to claim 1 can function as an all-optical switch which may be used as a quantum logic gate.

4. The device according to claim 1 can also be used to upconvert photon pairs of only certain polarizations by phase-matching considerations (for example, if type-I phase matching is used, the photons are upconverted only if both photons are vertically-polarized).

5. The device according to claim 1 is capable of changing the phase of photon pairs in the input beams, ie. enabling one photon to modify the phase of another optical beam.

6. The device according to claim 1 can also be used to change the phase of photon pairs of only certain polarizations by phase-matching considerations (for example, if type-I phase matching is used, the phase may be shifted only if both photons are vertically-polarized)

7. The device according to claim 1 may be used to perform quantum information tasks including, but not limited to, efficient Bell-state determination.

8. The device according to claim 1 can be used to implement quantum dense-coding.

9. The device according to claim 1 works even when there is, on average, less than a photon at a time in each input beam.

10. A method of optical switching, comprising;
directing multiple pump and signal laser beams impinge on an optically nonlinear medium in such a way so that quantum interference occurs between the input pump fields and the fields generated by the nonlinearity, said interference sum giving rise to greatly enhanced effective nonlinearities.

11. The method according to claim 10 wherein said polarization, frequency, direction and phase of the signal laser beams are adjusted in a selected manner to constitute an efficient all-optical switch at, near, or below the single-photon level.

12. The method according to claim 11 wherein three beams are incident on a frequency-doubling (x(2)) medium to large enhancements of the two-photon upconversion probability, or of cross-phase modulation.
